(19) United States
(12) Patent Application Publication
(10) Pub. No.: US 2003/0172200 A1
(43) Pub. Date: Sep. 11, 2003

(54) System and method for dynamically managing and facilitating logistics warehouse management system data via a computer network

(76) Inventors: Maureen Chen, Lakewood, CA (US); Jack Chen, Lakewood, CA (US)

Correspondence Address: Marlene Redde Kopp, 333 Washington Blvd, #24, MDR, CA, 90292, US

(21) Appl. No.: 10/093,688

(22) Filed: Mar. 8, 2002

(51) Int. Cl. G06F 3/00; G06F 17/60

(52) U.S. Cl. 710/3; 705/28

(57) ABSTRACT

The present invention comprises a system and method for accessing and managing logistics warehouse management system data, to allow the efficient management and retrieval of information and aggregation of information for use in tracking and generating reports specific to warehouse management system industry. The method and system of the present invention is correlated to the overall operations of third party logistic providers. The logistics warehouse management system data is easily accessible via standard graphic user interfaces to process data input, data tracking, and report generating applications, which present information in response to a client inquiry.

### COPYRIGHT NOTICE

A portion of the disclosure of this patent document contains material that is subject to copyright protection. The copyright owner has no objection to the facsimile reproduction by anyone of the patent document or patent disclosure as it appears in the Patent and Trademark Office, patent file or records, but otherwise reserves all copyright rights whatsoever.

### BACKGROUND OF THE INVENTION

1. Field of the Invention

The present invention relates to methods and apparatus for the logistics management and more specifically to a computer software program and method optimized for a method and system of tracking information with respect to the logistics industry. More particularly, the invention relates to a system and method of operation to sustain data query and data report retrieval with respect to logistics warehouse management system. The logistics warehouse management system is suitable for deployment on a single-user user computer or on a network comprising multiple computers.

2. Description of the Prior Art

The third party logistics industry encompasses managing the many functions and the varied services necessary for international trade. An essential component of the third party logistics industry is warehouse system management. The various logistics warehouse tasks, such as inventory, order fulfillment, transportation of goods and tracing of goods, are managed by a computerized logistics warehouse management system. Accordingly, the third party logistics warehouse management system comprises numerous independent fields of information; each of which must be monitored for a truly effective operation. For example, monitoring of information is required in the following fields: client, stock keeping unit (SKU), receivables, picking, invoice, and inventory reports. Said fields further comprise the sub-fields as follow: (i) client: add new client, look up client, and list client; said client fields may be manipulated by either client name or by client number; (ii) SKU/receive: set up new SKU; add inventory; look for a SKU number, look for a SKU name, look up a receive date, SKU inventory by SKU number for all transactions; (iii) picking: new pick ticket, find by pick number, find by pick date, system-generated new pick ticket, client-generated new pick ticket; (iv) invoice: locate an invoice, system-generated new invoice; (v) inventory reports: inventory report by client number, inventory report by history, inventory report by client name, inventory report by summary, inventory report by location, inventory report b SKU number, inventory report by receive date.

As the foregoing list of fields indicates, the third party logistics warehouse industry comprises numerous independent parties responsible for providing the aforementioned list of services; each of which the client must remain apprised of the status of the many information fields and the status of the of any particular account as a whole.

In the third party logistics warehouse industry, there exist various computer programs, that are designed specifically for the warehouse industry. However, the central point of such programs is primarily on inventory control, as opposed to a relational database that responds to specific client queries. Equally important, is that such programs function as a stand-alone application focused on the warehouse portion of third party logistic operations only.

Nonetheless, as stated above, logistic warehouse management systems are a very necessary part of a greater whole; said whole being comprised of numerous independent parties including the consignee, the consignor, the shipper, the carrier and the receiver; all of which comprise the logistics process. There clearly exists a need in the industry for an integrated logistic warehouse management system that interfaces with the greater operations of a third party logistic service provider. The method and system of the present invention function to integrate the warehouse management system with the overall operations of a third party logistics provider in a scaleable, flexible architecture.

By way of example, a typical warehouse management user may typically enter all of the inventory information into a computer program designed for multi-field inventory data entry. Such methods serve to allow the user to select a particular inventory field to retrieve information input for that account, much like a spreadsheet function that is standard with most PC based operating systems. While such methods may be suitable for managing inventory information, they do not redress the significant problems of dynamically managing the warehouse management information or integrating the warehouse management information to the overall operations of a logistics provider via a relational database. Too, there exists no means whereby all of the parties to the transaction are apprised to a singular set of information that is dynamically managed.

There exists a need in the third party logistics industry for a warehouse management system and method that dynamically manages the multiple fields of warehouse information.

There further exists a need in the third party logistics industry for a warehouse management system and method that updates the multiple fields of information.

There further exists a need in the third party logistics industry for a warehouse management system and method that integrates the warehouse management system with the overall operations of a logistics provider.

There further exists a need in the third party logistics industry for a warehouse management system and method that allows all of the parties to the transaction access to the dynamically managed information real-time from geographically remote locations.

In view of the foregoing disadvantages inherent in the known prior art, the present invention provides a new system and method for dynamically managing the various fields of information and integrating dispersed parties in the logistics warehouse management system industry. In this respect, the system and method for dynamically managing and facilitating logistics warehouse management system data according to the present invention, substantially departs from the conventional concepts and designs of the prior art, and in so doing provides an apparatus primarily developed for the purpose system and method dynamically managing and facilitating logistics warehouse management system data. Further novel features and other objects of the present invention will become apparent from the following detailed description, discussion and the appended claims, taken in conjunction with the drawings.

### SUMMARY OF THE INVENTION

The general purpose of the present invention, which will be described subsequently in greater detail, is to provide a system and method for dynamically managing and facilitating logistics warehouse management system data, that is not anticipated, rendered obvious, suggested, or even implied by any of the prior art, either alone or in any combination thereof. The system is highly flexible and adaptable and thus the invention can be implemented in many forms.

Therefore, it will be understood that the invention provides a collection of building blocks or program objects which can be assembled in a variety of different ways to easily construct a logistics warehouse management system for almost any application.

The present invention is a system and method for storing logistics warehouse management system data to allow efficient management and retrieval of information and aggregation of information for use in tracking and generating useful reports specific to warehouse management but correlated to overall third party logistic operations.

The logistics warehouse management system data is easily accessible via standard graphic user interfaces to process data input, data tracking, and report generating applications, which present information in response to a client inquiry.

The logistics warehouse management system formats the fields into available reports, which includes all available event fields that are essential for generation of a particular report. The reports may be manipulated by query or data input by the client. The reports are received, via a standardized communications interface, to a client computer system, where the report is stored and made available via a standard communications interface for easy access (i.e., a single query) by report generating applications. The logistics warehouse management system stores input data in a plurality of related tables each associated with a particular field type. The tables include tables that contain a subset, relating to a particular type of reporting, of the available fields for a given query.

Described briefly, the method of the present invention is a software application for use with a computer including a host computer server, a processor for executing code, input/output devices for providing data, memory for storing account data, internet connectivity and a customer local computer system. In operation, a plurality of transaction type fields are displayed on the browser of a customer's local computer system. In response to selecting of one of the transaction fields, a corresponding entry sequence is executed. The execution causes a display of one or more entry fields for receiving transaction data in response to the execution of the entry sequence. The transaction data is entered in response to the entry sequence and the entry fields displayed. The transaction data entered is stored in a database account that corresponds to the selected one of the transaction fields. Each account has a plurality of fields for data. The entry fields presented by the entry sequence are only the ones necessary for the particular transaction as determined by the selected transaction field and the corresponding entry sequence.

In one embodiment, the present invention is a real-time inventory tracking method and system of information management associated with thereto. A customer wishing to utilize the present invention executes a graphic user interface (hereinafter referred to as the “GUI”) on the browser of the customer's computer system to interface with the functions and features of the present invention. The interface connects the customer via the internet, or other means of TCP/IP connectivity, such as a Local Access Network (hereinafter referred to as a “LAN”) or a Wide Access Network (hereinafter referred to as a “WAN”) to the host computer server.

To initiate a transaction request, the customer structures the transaction request through the GUI; said GUI manages the information associated with a particular transaction cycle. To begin a transaction, the customer selects the appropriate transaction field, i.e., customer number, pick number, etc. and inputs the required information using a local computer system. The selection of a particular transaction, also selects a predetermined transaction entry sequence by which transaction data is entered by the user.

The transaction entry sequence automatically steps the user through a sequence to access one or more fields using only a pre-selected subset of the full set of fields associated with the account.

After inputting all of the required transaction information, as prompted by the GUI, the customer uploads the information to the host computer server for real-time processing of said information in the form of a status report. The host computer server dynamically computes the transaction information input by the customer, and posts the calculated information for retrieval on the browser of the customer local computer system. By way of example, a customer wishing a report on a stock keeping unit (SKU) inputs the necessary information such as SKU name, SKU number, and the like, as prompted by the GUI (thereby making the present invention simple to operate and error free); uploads said information to the host computer server for real-time computation of the input information in the form of a status report. The host computer server computes the requested information such as client, SKU, receive, picking, invoice, and inventory reports, and the like, and posts said real-time computed information for retrieval by the customer using the GUI.

In another embodiment of the present invention, the customer accesses a website after structuring a transaction request to receive real-time updates on the computed information. To wit: after structuring an information request, a customer may elect to establish a transaction account with the host computer server. Said transaction account comprises many fields of information, all of which are dynamically managed and updated on a real-time basis. The fields of information may include, but are not limited to: client, SKU/receive, picking, invoice, and inventory reports, and the like.

A customer may access the requested information via the internet or other means of TCP/IP connectivity using the GUI, to retrieve real-time updates regarding the status of a particular piece of information, or groups of information. By way of example, a customer may request information regarding a client, SKU/receive, picking, invoice, and inventory reports, or related logistics information such as the carrier, agent, port, delivery date and the like, and receive a real-time update from the host computer server. The GUI provides the ability to select from among several accounts to provide an easy method for selecting and switching between accounts, and this method is particularly useful in multiple account transaction environments. Other authorized parties may access the transaction account to input information and to retrieve information.

The present invention uses a simple visual interface, that is easy to learn, easy to use, and easy to remember how to use, thereby making the entry of transaction data fast and simple. Likewise, the user need not compute the many pieces of information required to facilitate the complicated shipping process. Rather, the user is guided by the GUI and the information is managed by the host computer server thereby saving the customer vat amounts of time and money.

Among the many advantages of the warehouse management system as put forth in the present invention: (i) access to an integrated set of information that may be accessed by different, independent fields; (ii) access to an integrated set of information that may be accessed by different, independent queries; (iii) a significant reduction in inventory management costs; (iv) effective and reliable order and inventory tracking; (v) fulfillment accuracy; and (vi) a method and system of warehouse management which can be adapted to virtually any shipping operation.

It has been discovered, according to the present invention, that if logistic warehouse management system providers can compute a multitude of information fields, and access such information on a readily accessible medium, that customers will save substantial amounts of time and money.

It has further been discovered, according to the present invention, that if logistic warehouse management system providers can compute a multitude of information, and allow customers to update and manipulate such information on a readily accessible medium, that customers will save substantial amounts of time and money.

It has further been discovered, according to the present invention, that if logistic warehouse management system providers can integrate their databases with the various third party logistic parties' databases, that customers will save substantial amounts of time and money.

It is therefore an object of the present invention to provide customers with the ability to compute a multitude of information fields, and allow said customers to access such information on a readily accessible medium, thereby saving said customers substantial amounts of time and money.

It is therefore an object of the present invention to provide warehouse management system providers with the ability to compute a multitude of information, and allow such customers to update and manipulate such information on a readily accessible medium, such as the internet, thereby saving said customers substantial amounts of time and money.

It is therefore an object of the present invention to provide warehouse management system providers with the ability to integrate their databases with the various third party logistic parties' databases, that customers will save substantial amounts of time and money, thereby saving said customers substantial amounts of time and money.

There has thus been outlined, rather broadly, the more important features of the invention in order that the detailed description thereof may be better understood, and in order that the present contribution to the art may be better appreciated. There are additional features of the invention that will be described hereinafter. In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of the description and should not be regarded as limiting.

### BRIEF DESCRIPTION OF THE DRAWINGS

FIG. 1A is a diagram of a host system in which the present invention may be advantageously applied.

FIG. 1B is a diagram of a host system in which the present invention may be advantageously applied.

FIG. 1C is a diagram of a host system in which the present invention may be advantageously applied.

FIG. 1D is a diagram of a host system in which the present invention may be advantageously applied.

FIG. 1E is a diagram of a host system in which the present invention may be advantageously applied.

### DETAILED DESCRIPTION OF THE PREFERRED EMBODIMENT

While the invention is susceptible to various modifications and alternative forms, a specific embodiment thereof has been shown by way of example in the drawings and will herein be described in detail. It should be understood, however, that it is not intended to limit the invention to the particular form disclosed, but on the contrary, the invention is to cover all modifications, equivalents, and alternatives falling within the spirit and scope of the invention as defined by the appended claims.

1. Description of the Preferred Embodiment

The present invention is a system and method for storing logistics warehouse management system data to allow efficient management and retrieval of information and aggregation of information for use in tracking and generating useful reports. The logistics warehouse management system data is easily accessible via standard graphic user interfaces to process data input, data tracking, and report generating applications, which present information in response to a client inquiry.

The logistics warehouse management system formats the fields into available reports, which includes all available event fields that are essential for generation of a particular report. The reports may be manipulated by query or data input by the client. The reports are received, via a standardized communications interface, to a client computer system, where the report is stored and made available via a standard communications interface for easy access (i.e., a single query) by report generating applications. An aggregation function summarizes collected data and maintains a count of each field type. The logistics warehouse management system stores input data in a plurality of related tables each associated with a particular field type. The tables include tables that contain a subset, relating to a particular type of reporting, of the available fields for a given query.

As more fully described herein, the logistics warehouse management system of the invention employs a multitasking database for running a plurality of computer processes that generate customized reports in response to data input in the form of a query by the client. The client computer system employs a graphic user interface to input information from a user about a desired report or information request and to provide output information. The output information may be in the form of information displayed on the screen of the client's computer, or in the form of a report.

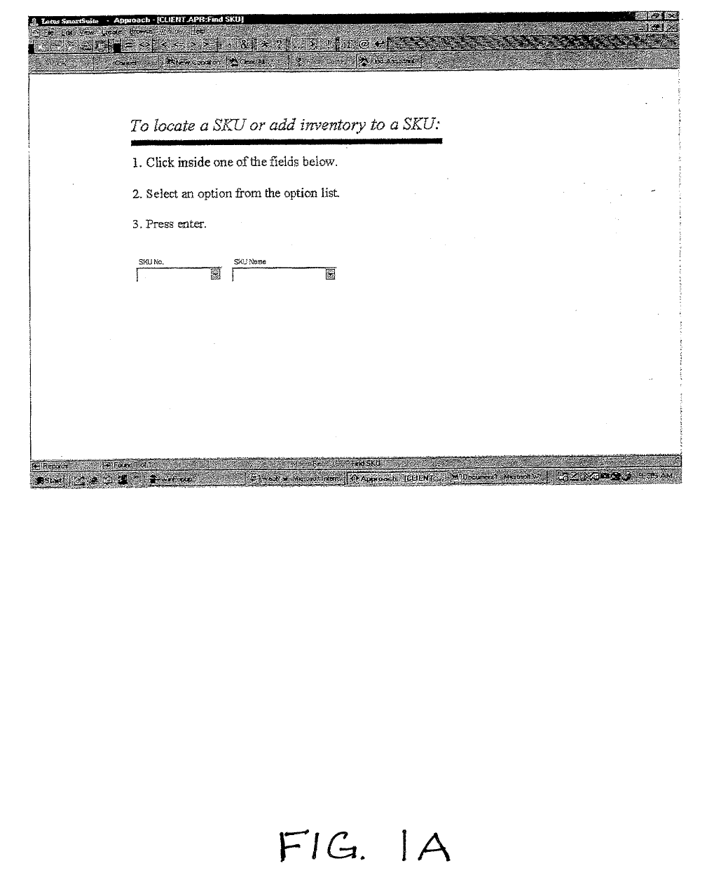

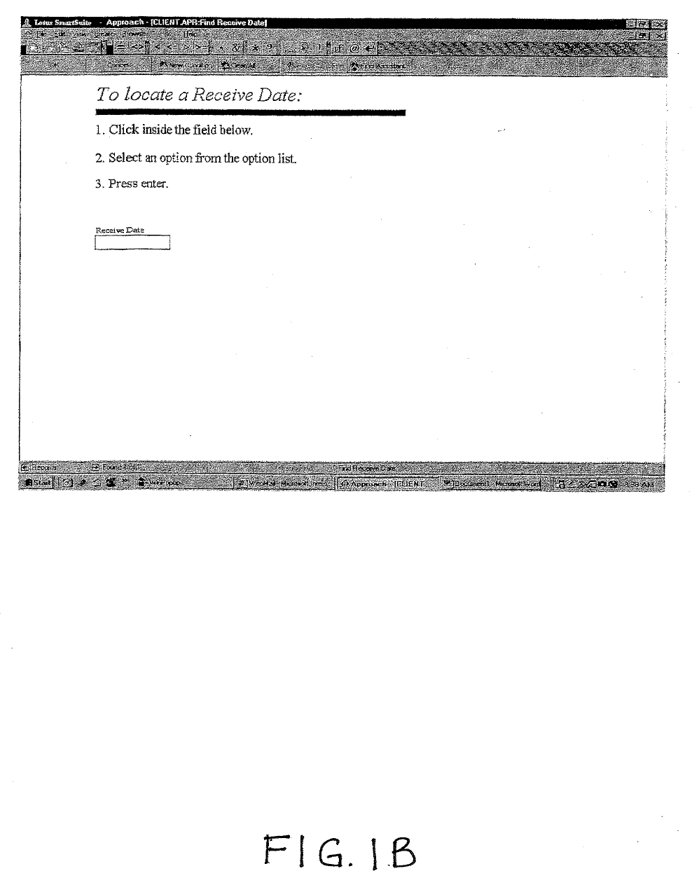

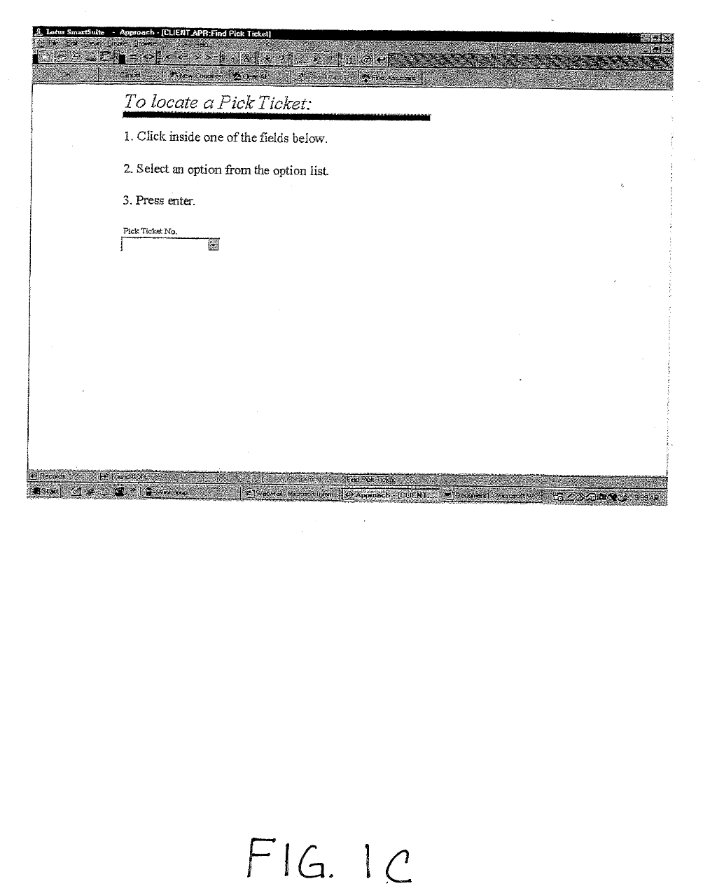

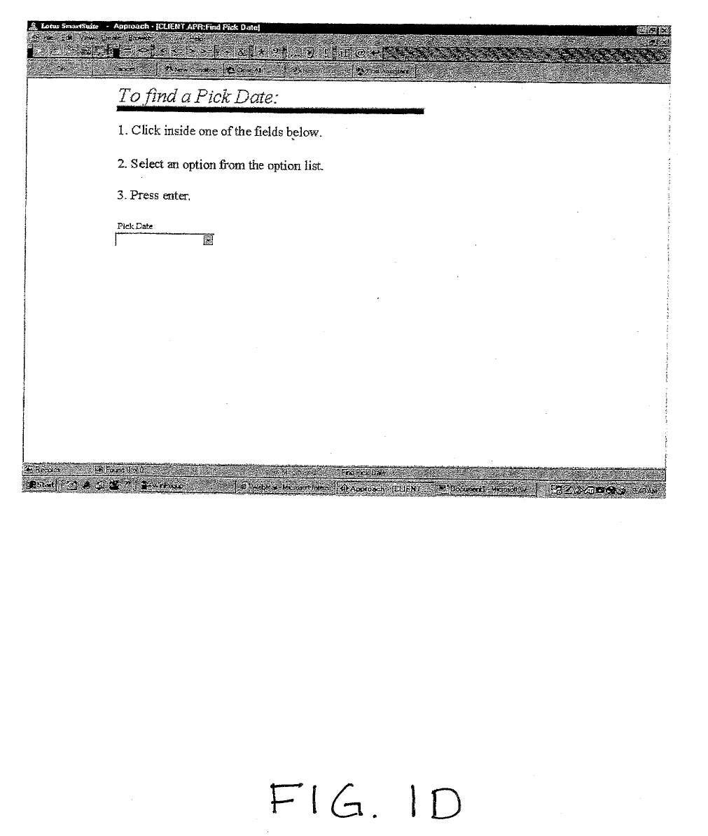

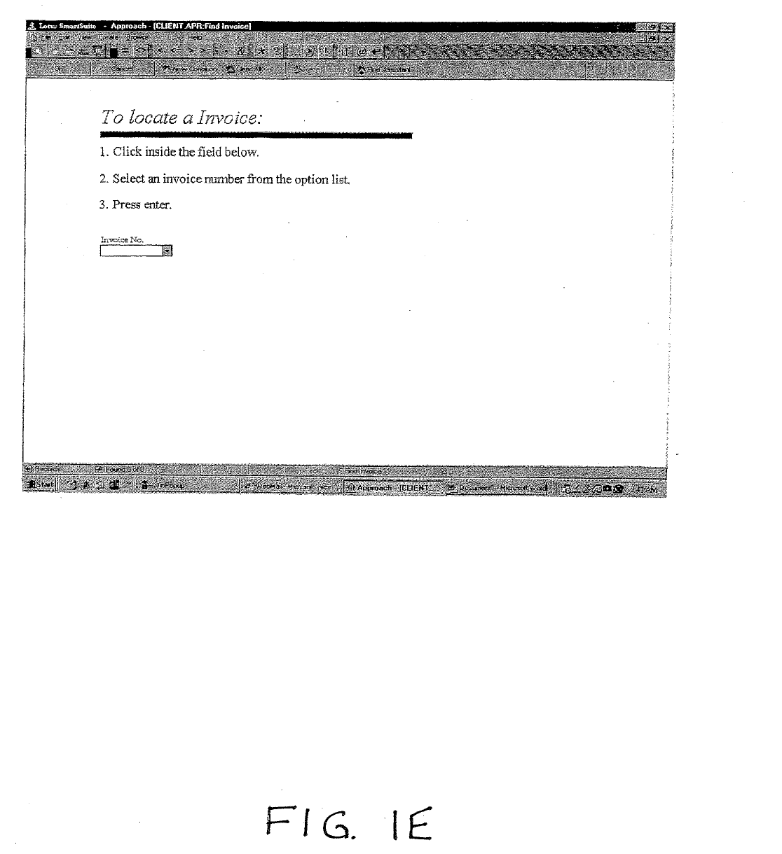

With reference to FIG. 1, the system of the present invention comprises the internet or other TCP/IP base networks, a customer computer system, a graphic user interface, a host computer server, and host computer server databases. The computer of FIG. 1 includes a conventional processor 10, input/output (I/O) devices 11, memory 12 and display 13 of the graphic user interface. The memory 12 stores the operating system 16 for the computer 5, executable computer software 14 which implements the real-time input and real-time tracking method of the present invention and includes the host computer server database 15 where transaction data is stored.

Said computer databases are configured to dynamically manage the various information associated with a third party logistics provider. In accordance with the invention, the logistics warehouse management system includes a plurality of event fields, including, but not limited to, client, stock keeping unit (SKU), receive, picking, invoice, and inventory reports. Said fields further comprise the sub-fields as follow: (i) client: add new client, look up client, and list client; said client fields may be manipulated by either client name or by client number; (ii) SKU/receive: set up new SKU; add inventory; look for a SKU number, look for a SKU name, look up a receive date, SKU inventory by SKU number for all transactions; (iii) picking: new pick ticket, find by pick number, find by pick date, system-generated new pick ticket, client-generated new pick ticket; (iv) invoice: locate an invoice, system-generated new invoice; (v) inventory reports: inventory report by client number, inventory report by history, inventory report by client name, inventory report by summary, inventory report by location, inventory report by SKU number, inventory report by receive date.

Said computer databases comprise a dynamically driven proprietary arrangement of information that cumulatively serve to efficiently manage and track the various information associated with a logistics warehouse management system provider. Said host computer databases include the following fields: client, stock keeping unit (SKU), receive, picking, invoice, and inventory reports. Further, said host computer databases are able to integrate with the following fields: bill of lading details, house bill of lading, notification, consignee notification, quotation, shipment, bookings, customers, commodity, consignee commodity, consignee follow up, sales, routing order, shipper, agent, house bill consignee commodity, release order, warehouse, release order details, truck, arrival notice, business categories, companies, company branches, agent carrier, ports and carrier.

The customer accesses the present invention using a local computer system that runs a stand-alone application from a remote location (i.e. the home, office, or a laptop), or by running a computer which establishes internet or TCP/IP connectivity with a host computer server using the database graphic user interface. The customer may be, but need not be, the end user, or an authorized party requesting information regarding a particular account. The graphic user interface runs on the browser of the customer local computer system and provides the interface that allows the customer to operate the present invention by the processes and methods described herein. With respect to the customer, the graphic user interface is the device that allows the customer to access the present invention, establish a registration account with the host computer server, navigate the database, and to download and upload information from the host computer server.

The present invention comprises an application that dynamically manages and tracks the many components associated with a warehouse management system provider from the point of initiation by the customer to the end point of delivery of the requested information query or report.

Initially, in a real-time embodiment of the present invention whereby the application is a function of the hose computer, the customer must register with the host computer server which in turn establishes a customer registration account in the database. The customer registration account is the basis upon which the database correlates transaction information and keeps a tracking record of the parties and information peculiar to a particular transaction. The database is a function of the host computer server. The database repository consists of various components of information that are specific to certain transactions and certain sectors or industries related to warehouse management system providers and to third party logistic providers.

With reference to the above method and system, a customer with internet or TCP/IP connectivity may either a website, a local access network (LAN) or a wide access network (WAN) using a client-server infrastructure, to provide the point of access to the present invention. In the preferred embodiment of the present invention, the request for third party logistic services is initiated by the customer accessing a website on the world-wide-web using the customer local computer system. The website provides the customer with information about the services available an information in the form of a tutorial on how to register with, and use the present invention. Alternatively, the invention may be configured for use an a restricted LAN or a restricted WAN.

With reference to the above method and system, registration with the host computer database is a prerequisite to using the present invention by the customer. With respect to the customer, registration enables the host computer server to correlate electronic information requests selected by the customer with that particular customer and with all other authorized parties as identified by the customer during the registration process. Registration further allows the host computer server to associate all electronic information requests with that particular registration account. The tracking mechanism of the host computer server is integral to the function of the present invention for the purpose of managing the transaction cycle, as more fully described below.

2. Operation of the Preferred Embodiment

As the foregoing list indicates, the many pieces of information necessary to operate a logistics warehouse management system provider operation are numerous. The present invention serves to dynamically manage and update the various information on a real-time basis, and to allow the end users of the information access to the various information on a real-time basis. FIG. 1 further depicts a egg 18 representation of the various components of the transaction cycle executed by the system and the components thereof.

The transaction display is the software which causes the system to concurrently display a plurality of transaction fields client, stock keeping unit (SKU), receive, picking, invoice, and inventory reports. Said fields further comprise the sub-fields as follow: (i) client: add new client, look up client, and list client; said client fields may be manipulated by either client name or by client number; (ii) SKU/receive: set up new SKU; add inventory; look for a SKU number, look for a SKU name, look up a receive date, SKU inventory by SKU number for all transactions; (iii) picking: new pick ticket, find by pick number, find by pick date, system-generated new pick ticket, client-generated new pick ticket; (iv) invoice: locate an invoice, system-generated new invoice; (v) inventory reports: inventory report by client number, inventory report by history, inventory report by client name, inventory report by summary, inventory report b location, inventory report by SKU number, inventory report by receive date.

Each field has a variety of components particular to that aspect of the transaction. By way of example, for a “SKU/receive” function of the transaction, said function further comprises the fields of SKU number, SKU name, client ID, weight, measurement, FIFO, conversion. Such field information is also dynamically correlated to pick and receive information. The corresponding fields operate in the same manner as the foregoing example indicates. Any number of such transaction fields may be depicted by the graphic user interface. For each field displayed by the graphic user interface, a corresponding customer account exists.

The operation of the tracking of each customer account as executed by the host computer server occurs as follows. When the computer system of FIG. 1 is turned on or is otherwise initialized, the tracking code in the memory of FIG. 1 automatically executes image code to display the transaction field images. In this mode, the display waits until a end user through the an I/O device selects one of the field images. The selected one of the fields causes entry of data into one of the transaction fields for the purposes of real-time data input and transaction management which corresponds to the selected one of the fields; for example the SKU reference listed above.

Assuming that the field is selected, the transaction entry sequence is then executed. The transaction entry sequence causes one or more transaction display fields (or sequences of fields) to be displayed. Depending on the complexity of the transaction, the display field may include different fields which is a total of fields. Upon display of a transaction display field, corresponding to the transaction entry, data entry is executed, to receive real-time transaction data particular to that portion of the transaction the transaction, such as SKU, pick, customer and the like. Upon execution of data entry, the information is stored into the corresponding user transaction accounts. The FIG. 1 embodiment is only one embodiment where certain predetermined fields associated with a customer account are automatically supplied through the entry sequencing. These automatic operations of FIG. 1 greatly simplify the operations required by a customer and provide instant access on a real-time basis to the customer or end user.

The data entry for a transaction is controlled by a transaction entry sequence whereby entry fields are displayed via a screen form, window, dialog or other display field using any I/O device such as a keyboard, touch screen, pen, stylus, mouse, voice, an external device such as a terminal, network link, telephone link, host computer or any other device that inputs data to each field displayed in sequence. The sequence of transaction fields is a function of account type as selected by the customer or end user. For each transaction field, there is a display sequence of the fields with appropriate attributes, and associated prompts, corresponding to the transaction. As an example, a “shipment” field has a subset of fields together which cumulatively provide information with respect to that aspect of the transaction; dependent upon which part of the shipment transaction that the customer or end user requires information about.

A view may be for any single transaction showing all the information that was originally entered. Optionally, a view may list other information such as the reconciled balance, the total of all transactions that have been marked as reconciled. Optionally, a view may list transactions or totals of transactions for some or all accounts. Optionally, a view may list transactions or totals of transactions grouped by an attribute, such as category.

The first step is to set up the transaction data structure. Then, the transaction display fields of the form are set up which sets up the user interface on the form. The values in the display fields are initialized which sets up each attribute, e.g. (i) client: add new client, look up client, and list client; said client fields may be manipulated by either client name or by client number; (ii) SKU/receive: set up new SKU; add inventory; look for a SKU number, look for a SKU name, look up a receive date, SKU inventory by SKU number for all transactions; (iii) picking: new pick ticket, find by pick number, find by pick date, system-generated new pick ticket, client-generated new pick ticket; (iv) invoice: locate an invoice, system-generated new invoice; (v) inventory reports: inventory report by client number, inventory report by history, inventory report by client name, inventory report by summary, inventory report by location, inventory report by SKU number, inventory report by receive date.

The transaction entry sequence is defined by the layout and selection of transaction display fields on the form. Selection also defines the user interface, as described above. When the user hits the “save” command, the host computer server is called to gather data from the display fields using the pre-determined database functions. Finally, to save the transaction into the account, invokes the storing code. The sequence of display fields is a function of transaction type as selected by the transaction field image. For each transaction image, there is a display sequence of the fields with appropriate attributes, and associated prompts, corresponding to the transaction. As an example, a “quotation” field image or form has a “quote date” field together with an “effective date” and “amount” fields. Some field forms share attributes with other forms, and all field forms typically dynamically manage a subset of information.

The process of performing calculations and logic is displayed as information about transactions in an account and other information about the account. A view on a customer's graphic user interface may be for any single transaction showing all the information that was originally entered, or as modified by the customer. Optionally, a view may list transactions or totals of transactions for some or all accounts. Optionally, a view may list transactions or totals of transactions grouped by an attribute, such as category. Examples of viewing operations that are performable with the computer and software include the following: query database for a list of accounts; for each account, compute transaction data requested by the customer, such as warehouse and bond number; and display the account information in the appropriate format.

The host computer server sets up the transaction data structure, along with the transaction display fields of the form which in turn are set up on the user interface on the form. The values in the display fields are initialized which sets up each attribute, e.g. (i) client: add new client, look up client, and list client; said client fields may be manipulated by either client name or by client number; (ii) SKU/receive: set up new SKU; add inventory; look for a SKU number, look for a SKU name, look up a receive date, SKU inventory by SKU number for all transactions; (iii) picking: new pick ticket, find by pick number, find by pick date, system-generated new pick ticket, client-generated new pick ticket; (iv) invoice: locate an invoice, system-generated new invoice; (v) inventory reports: inventory report by client number, inventory report by history, inventory report by client name, inventory report by summary, inventory report by location, inventory report by SKU number, inventory report by receive date.

The transaction entry sequence is defined by the layout and selection of transaction display fields on the form. When the user hits the save command, the database is called to gather data from the information fields using the predetermined host computer server functions.

The graphic user interface further comprises a visual representation (image) that is recognizable as a symbol for identifying a transaction, an account, an attribute of an account or other information relating to an account. The visual representations are displayed as fields, icons, buttons, or other similar likenesses. Selecting a transaction image activates a transaction entry sequence. For each account or any other attribute, the present invention can display the transactions it comprises in a list on-screen or in printed form.

Reports are generated by system hardware, the operating system, and applications running on the network. Field data in the logistics warehouse management system is stored in a plurality of related tables each associated with a particular field type. The tables include tables that contain a subset, relating to a particular type of reporting, of the available fields for a given query.

The formal data schema includes a set of tables that store the fields in a manner conducive to efficient retrieval of relevant information for various types of data retrieval. Accordingly, depending on the anticipated type of reporting that will be performed, only those fields that are essential to a particular type of reporting are stored in a corresponding table type. Each report request may have multiple different tables associated with it, each differing from one another by storing at least one different field. Accordingly, when a report request requires information relating to a particular type of field, a single query is performed on the appropriate table associated with that type of reporting to obtain all of the essential information for that particular report request.

Each table is defined to include all essential event fields required for its type of reporting. The drawings illustrate examples of reports in accordance with the formal data schema of the present invention. However, as described previously, each report type may include any number of different tables. By way of example, if a first type of reporting is performed, a query is performed inputting a customer number in particular. The present invention generates a report from across all fields that relate to said customer number input. Thus, the present invention performs a separate query on for every field essential to a particular type of reporting, in order to eliminate unnecessary information essential to that type of report request.

A query function provides a method for summarizing information about a data or report request without presenting all of the information associated the request. The function supports a database that may be manipulated by allowing the client to request specific data from the database while retaining related information about the particular request. The usefulness of query function is that a report can be generated about the aggregate information, with a data specific for each particular field and corresponding subsets.

The terms used in connection with transaction tracking are defined as follows:

Account

A totality of transactions (together with accumulated totals and other information). Examples of accounts are (i) client: add new client, look up client, and list client; said client fields may be manipulated by either client name or by client number; (ii) SKU/receive: set up new SKU; add inventory; look for a SKU number, look for a SKU name, look up a receive date, SKU inventory by SKU number for all transactions; (iii) picking: new pick ticket, find by pick number, find by pick date, system-generated new pick ticket, client-generated new pick ticket; (iv) invoice: locate an invoice, system-generated new invoice; (v) inventory reports: inventory report by client number, inventory report by history, inventory report by client name, inventory report by summary, inventory report by location, inventory report by SKU number, inventory report by receive date.

Transaction

An operation that identifies a transfer in connection with an account. A transaction typically has the following attributes, customer, date, account, and transaction type.

The database comprises the means for storing multiple transactions for an account, albeit each transaction is typically for only one account. Each account has a balance or total, which is the sum of the amounts of the transactions in that account. Once recorded in the account store, each transaction can be subsequently edited or deleted by the customer or the host computer server.

Transaction Entry Sequence

The data entry for a transaction is controlled by a transaction entry sequence whereby entry fields are displayed via a screen form, window, dialog or other display field using any I/O device such as a keyboard, touch-screen, pen, stylus, mouse, voice, an external device such as a network link, telephone link, host computer or any other device that inputs data to each field displayed in sequence. The sequence of display fields is a function of account type as selected by the transaction field. For each transaction image, there is a display sequence of the fields with appropriate attributes, and associated prompts, corresponding to the transaction. As an example, a “SKU/receive” form further comprises an “client ID” field together with an “SKU number” and “conversion” fields.

Some forms share attributes with other forms, but typically as a minimum all forms have the following information, in whole or in part, (i) client: add new client, look up client, and list client; said client fields may be manipulated by either client name or by client number; (ii) SKU/receive: set up new SKU; add inventory; look for a SKU number, look for a SKU name, look up a receive date, SKU inventory by SKU number for all transactions; (iii) picking: new pick ticket, find by pick number, find by pick date, system-generated new pick ticket, client-generated new pick ticket; (iv) invoice: locate an invoice, system-generated new invoice; (v) inventory reports: inventory report by client number, inventory report by history, inventory report by client name, inventory report by summary, inventory report by location, inventory report by SKU number, inventory report by receive date.

Host Computer Server Calculation

The process of performing calculations and logic to display information about transactions in an account and other information about the account. A calculation may be for any single transaction showing all the information that was originally entered about the account or any one piece of information about the account. Optionally, a calculation may list some information, or the total of all transaction information that have been selected by the customer. Optionally, a view may list transactions or totals of transactions grouped by an attribute, such as category. Examples of viewing operations that are performable with the computer and software include the following: (i) client: add new client, look up client, and list client; said client fields may be manipulated by either client name or by client number; (ii) SKU/receive: set up new SKU; add inventory; look for a SKU number, look for a SKU name, look up a receive date, SKU inventory by SKU number for all transactions; (iii) picking: new pick ticket, find by pick number, find by pick date, system-generated new pick ticket, client-generated new pick ticket; (iv) invoice: locate an invoice, system-generated new invoice; (v) inventory reports: inventory report by client number, inventory report by history, inventory report by client name, inventory report by summary, inventory report by location, inventory report by SKU number, inventory report by receive date.

As will be appreciated by those skilled in the art, the invention as herein described provides a method for organizing the data input from the logistics warehouse management system; said data input is stored in a plurality of related tables each associated with a particular field type. The tables include tables that contain a subset, relating to a particular type of reporting, of the available fields for a given query. In addition, the invention provides a mechanism to manipulate the data depending on the data query request and make specific reports in response to the client query.

There has thus been outlined, the more important features of the invention in order that the present contribution to the art may be better appreciated. It is to be understood that the invention is not limited in its application to the details of construction and to the arrangements of the components set forth in the foregoing description or illustrated in the drawings. Although the invention has been described in terms of the illustrative embodiments, it will be appreciated by those skilled in the art that various changes and modifications may be made to the illustrative embodiments without departing from the spirit or scope of the invention. It is intended that the scope of the invention not be limited in any way to the illustrative embodiment shown and described but that the invention be limited only by the claims appended hereto.

What is claimed is:

1. In a clustered computing network having a plurality of computers connected to a plurality of storage devices through a plurality of adapters, a system for warehouse system management of I/O requests including: a communication medium interconnecting said plurality of adapters for peer to peer communication there between a directory stored in a memory within at least one of said plurality of adapters for storing location information regarding blocks of data stored within said plurality of storage devices; and managing means operable within said at least one adapter of said plurality of adapters and associated with said communication medium and with said directory for selecting which of said plurality of adapters should process a received I/O request from one of said plurality of computers and for shipping said receive I/O request via said communication medium to another of said plurality of adapters in response to the selection, wherein said managing means is operable within said at least one adapter independent of said plurality of computers and is operable to ship a received I/O request to said another of said Plurality of adapters transparently with respect to said plurality of computers.

2. The system of claim 1 wherein said managing means includes: updating means within said at least one adapter for revising said directory with information regarding the location of blocks of data within at least one of said plurality of storage devices.

3. The system of claim 2 wherein said updating means is operable for updating said directory in response to receiving location information from said plurality of adapters regarding blocks of data.

4. The system of claim 1 wherein said directory includes: a local portion corresponding to data stored in a portion of said plurality of storage devices connected to said one of said plurality of adapters; and a remote portion corresponding to a portion of said plurality of storage devices connected to others of said plurality of adapters.

5. The system of claim 4 wherein said managing means includes: searching means to search said local portion and said remote portion of said directory to select which of said plurality of adapters should process the received I/O request; first determining means for deciding whether said at least one adapter can process the received I/O request in response to said searching means locating the requested blocks in said local portion; and second determining means for deciding whether another of said plurality of adapters can process the received I/O request in response to said searching means locating the requested blocks in said remote portion and in response to said first determining means.

6. The system of claim 1 wherein said storage devices include disk arrays.

7. The system of claim 6 wherein said storage devices further include RAID management means to store data.

8. The system of claim 1 wherein at least one computer of said plurality of computers creates said directory and distributes said directory to said plurality of adapters.

9. The system of claim 8 wherein said system further comprises: updating means in said at least one computer to update said directory and to distribute the updated directory to said plurality of adapters.

10. The system of claim 1 wherein said at least one of said plurality of adapters creates said directory and distributes said directory to others of said plurality of adapters.

11. The system of claim 10 wherein said managing means further comprises updating means to update said directory and to distribute the updated directory to others of said plurality of adapters.

12. A method for shipping of data block I/O requests among a plurality of adapters which connect a plurality of storage devices to a plurality of computers in a clustered computer network, said method comprising the steps of:
determining, within said plurality of adapters, which of said plurality of adapters should process a received I/O request from one of said plurality of computers; communicating among said plurality of adapters via said communication medium to ship said received I/O request from one of said plurality of adapters to another of said plurality of adapters for processing, wherein the method is operable within said plurality of adapters independent of said plurality of computers and is operable to ship a received I/C request to said another of said plurality of adapters transparently with respect to said plurality of computers.

13. The method of claim 12 wherein the step of determining includes the step of searching a directory, within said plurality of adapters, that includes location information regarding blocks of data within said plurality of storage devices.

14. The method of claim 13 wherein said directory includes a local portion corresponding to data stored in a portion of said plurality of storage devices connected to said one of said plurality of adapters and a remote portion corresponding to a portion of said plurality of storage devices connected to others of said plurality of adapters, and wherein the step of searching includes the steps of:
searching said local portion to determine whether said one of said plurality of adapters can process said I/O request; and searching said remote portion to determine whether another of said plurality of adapters can process said I/O request in response to the determination that said one of said plurality of adapters cannot process said I/O request.

15. The method of claim 12 further including the step of creating a directory which maps the location of blocks of data within at least one of said plurality of storage devices.

16. The method of claim 15 wherein the step of creating a directory further includes the step of distributing said directory to said plurality of adapters.

17. The method of claim 16 wherein the step of creating a directory further includes the steps of coalescing information regarding the location of blocks of data within said plurality of storage devices; and building said directory using said coalesced information.

18. A system for I/O shipping of an I/O request comprising:
a plurality of host adapters for connecting at least one host computer that generates said I/O request to at least one I/O device; a communication medium interconnecting said plurality of host adapters, wherein said plurality of host adapters connect said at least one host computer to said communication medium; and shipping means within said plurality of host adapters and coupled with said communication medium, for shipping said I/O request to an identified one of said plurality of host adapters via said communication medium, wherein said shipping means is operable within said plurality of adapters independent of said at least one host computer and is operable to ship a received I/O request to said identified one of said plurality of adapters transparently with respect to said at least one host computer.

19. The system of claim 18 wherein said shipping means includes: a directory mapping the location of data in I/O devices of said at least one I/O device associated with said plurality of host adapters; and search means, coupled with said directory, for searching said directory to locate data requested by said I/O request to thereby identify said identified one of said plurality of host adapters capable of processing said I/O request.

20. The system of claim 19 wherein said directory includes: a local portion corresponding to data stored in a portion of said at least one I/O device connected to a corresponding one of said plurality of host adapters; and a remote portion corresponding to a portion of said plurality of said at least one I/C device connected to others of said plurality of host adapters.

21. The system of claim 20 wherein said search means includes: searching means, within at least one adapter of said plurality of host adapters, for searching said local portion and said remote portion of said directory to select which of said plurality of host adapters should process said I/O request; first determining means for deciding whether said at least one adapter can process the I/O request in response to said searching means locating the requested blocks in said local portion; and second determining means for deciding whether another of said plurality of host adapters can process the I/O request in response to said searching means locating the requested blocks in said remote portion and in response to said first determining means.

22. A clustered computer network, comprising: a first node, including: a first host computer with a first processor bus; a first bus bridge connected to said first processor bus; a first host bus adapter; a first peripheral bus connected to said first bus bridge and o1 said first host bus adapter, wherein said first bus bridge and said first peripheral bus provide communication between said first host computer and said first host bus adapter; and a first storage device that is accessed by said first host bus adapter; a second node, remote to said first node, including: a second host computer with a second processor bus; a second bus bridge connected to said second processor bus; a second host bus adapter; a second peripheral bus connected to said second bus bridge and said second host bus adapter, wherein said second bus bridge bus and said second peripheral bus provide communication between said second host computer and said second host bus adapter; and a second storage device that is accessed by said second host bus adapter; and an adapter communication medium that provides communication between said first and second host bus adapters, wherein said first host bus adapter routes I/O requests from said first host computer for said first storage device to said first storage device and ships I/O requests from said first host computer for said second storage device across said adapter communication medium to said second host bus adapter independent of said first host computer, thereby relieving said first host computer of determining which of said storage devices said I/O requests from said first host computer are directed to, and said second host bus adapter routes I/C requests from said second host computer for said second storage device to said second storage device and ships I/O requests from said second host computer for said first storage device across said adapter communication medium to said first host bus adapter independent of said second host computer, thereby relieving said second host computer of determining which of said storage devices said I/O requests from said second host computer are directed to wherein the shipping of I/O requests is transparent with respect to said first host computer and said second host computer.

23. The network of claim 22 further including a computer communication medium that provides communication between said first and second host computers, wherein said computer communication medium does not provide communication between said first and second host bus adapters, and said adapter communication medium does not provide communication between said first and second host computers.

24. The network of claim 22 wherein said first storage device includes a first array of disk drives, and said second storage device includes a second array of disk drives.

25. The network of claim 22 wherein said first and second host bus adapters communicate with one another in accordance with an I.sub.2 O protocol.

26. The network of claim 22 wherein said first host bus adapter responds to said I/O requests from said second host adapter by enabling said second host adapter to logically share said first storage device, and said second host bus adapter responds to said I/O requests from said first host bus adapter by allowing said first host bus adapter to logically share said second storage device.

27. The network of claim 22 wherein said first host bus adapter permanently physically owns said first storage device for I/O requests in said network for said first storage device and permanently logically shares said second storage device for I/O requests from said first host computer for said second storage device; and said second host bus adapter permanently physically owns said second storage device for I/O requests in said network for said second storage device and permanently logically shares said first storage device for I/C requests from said second host computer for said first storage device.

28. The network of claim 22 wherein said first host computer includes first processors, said first processor bus provides communication between said first processors, and said first peripheral bus provides communication between said first processors and said first host bus adapter without providing communication between said first processors; and said second host computer includes second processors, said second processor bus provides communication between said second processors, and said second peripheral bus provides communication between said second processors and said second host bus adapter without providing communication between said second processors.

29. The network of claim 22 wherein said first host bus adapter consists essentially of a first peripheral bus interface for interfacing with said first peripheral bus, a first internal bus connected to said first peripheral bus interface, a first internal bus bridge connected to said first internal bus, a first internal processor bus connected to said first internal bus bridge, a first central processing unit and a first memory connected to said first internal processor bus, a first storage device interface connected said first internal bus for interfacing with said first storage device, and a first adapter communication medium interface connected to said first internal bus for interfacing with said adapter communication medium; and said second host bus adapter consists essentially of a second peripheral bus interface for interfacing with said second peripheral bus, a second internal bus connected to said second peripheral bus interface, a second internal bus bridge connected to said second internal bus, a second internal processor bus connected to said second internal bus bridge, a second central processing unit and a second memory connected to said second internal processor bus, a second storage device interface connected said second internal bus for interfacing with said second storage device, and a second adapter communication medium interface connected to said second internal bus for interfacing with said adapter communication medium.

30. The network of claim 22 wherein said first host bus adapter includes a first routing host bus adapter for routing I/O requests for said first data storage device to said first data storage device, and includes a first shipping host bus adapter for shipping I/O requests from said first host computer for said second storage device to said second host bus adapter via said adapter communication medium and for transferring 1/O requests from said second host bus adapter via said adapter communication medium to said first routing host bus adapter for transfer to said first storage device; and said second host bus adapter includes a second routing host bus adapter for routing I/O requests for said second data storage device to said second data storage device, and includes a second shipping host bus adapter for shipping 1/O requests from said second host computer for said first storage device to said first host bus adapter via said adapter communication medium and for transferring I/O requests from said first host bus adapter via said adapter communication medium to said second routing host bus adapter for transfer to said second storage device.

31. The network of claim 30 wherein said first routing host bus adapter consists essentially of a first routing peripheral bus interface for interfacing with said first peripheral bus, a first routing bus connected to said first routing peripheral bus interface, a first routing bus bridge connected to said first routing bus, a first routing processor bus connected to said first routing bus bridge, a first routing central processing unit and a first routing memory connected to said first routing processor bus, and a first routing storage device interface connected to said first routing bus for interfacing with said first storage device; said first shipping host bus adapter consists essentially of a first shipping peripheral bus interface for interfacing with said first peripheral bus, a first shipping bus connected to said first shipping peripheral bus interface, a first shipping bus bridge connected to said first shipping bus, a first shipping processor bus connected to said first shipping bus bridge, a first shipping central processing unit and a first shipping memory connected to said first shipping processor bus, and a first shipping adapter communication medium interface connected to said first shipping bus for interfacing with said adapter communication medium; said second routing host bus adapter consists essentially of a second routing peripheral bus interface for interfacing with said second peripheral bus, a second routing bus connected to said second routing peripheral bus interface, a second routing bus bridge connected to said second shipping bus, a second routing processor bus connected to said second routing bus bridge, a second routing central processing unit and a second routing memory connected to said second routing processor bus, and a second routing storage device interface connected to said second routing bus for interfacing with said second storage device; and said second shipping host bus adapter consists essentially of a second shipping peripheral bus interface for interfacing with said second peripheral bus, a second shipping bus connected to said second shipping peripheral bus interface, a second shipping bus bridge connected to said second shipping bus, a second shipping processor bus connected to said second shipping bus bridge, a second shipping central processing unit and a second shipping memory connected to said second shipping processor bus, and a second shipping adapter communication medium interface connected to said second shipping bus for interfacing with said adapter communication medium.

32. A method for accessing and managing warehouse management system events, each of said events comprising one of a plurality of different field types, said field types further comprising:
receiving a warehouse management system request, said request comprising a plurality of fields;
extracting at least a first set of said plurality of fields from said warehouse management system;
storing said fields in a report-ready table in a relational database, said report-ready table capable of storing multiple fields and used by a report generator to generate a report, and said first set of said fields comprising each of said plurality of fields that are essential for generation of said report.
